(19) United States
(12) Patent Application Publication
(10) Pub. No.: US 2009/0158063 A1
(43) Pub. Date: Jun. 18, 2009

(54) METHOD AND DEVICE FOR DYNAMICALLY CONTROLLING POWER CONSUMPTION AND CONNECTION MODE OF NETWORK CARD

(75) Inventors: Pei Wang, Beijing (CN); Lin Xu, Beijing (CN)

Correspondence Address: DICKSTEIN SHAPIRO LLP, 1177 AVENUE OF THE AMERICAS (6TH AVENUE), NEW YORK, NY, 10036-2714, US

(73) Assignees: Beijing Lenovo Software Ltd., Beijing (CN); Lenovo(Beijing) Limited, Beijing (CN)

(21) Appl. No.: 12/334,171

(22) Filed: Dec. 12, 2008

(30) Foreign Application Priority Data
Dec. 14, 2007 (CN) 200710179553.8

(51) Int. Cl. G06F 1/00; G06F 15/173

(52) U.S. Cl. 713/300; 709/224

(57) ABSTRACT

The invention provides a method and a device for dynamically control power consumption and a connection mode of a network card, which relates to a power saving technique for the network card. The method comprises steps of: monitoring a data transmission state in a network in real time, and obtaining a statistic value for the data transmission state in a current or a predetermined period; obtaining a target connection mode matching with the current data transmission based on the statistic value, and switching the connection mode of the network card to the target connection mode. In the embodiments of the present invention, when a network connection is established, it is not forced to a certain connection mode. The connection mode may be dynamically varied according to a load task by monitoring the data transmission state in the network and comparing with a switching condition. The connection mode may be dynamically switched among respective modes, so as to improve efficiency of the transmission bandwidth and implement an optimal dynamic match of the bandwidth/power consumption.

### BACKGROUND OF THE INVENTION

1. Field of Invention

The present invention relates to a power saving technique for a network card, particularly to a method and a device for dynamically controlling power consumption and a connection mode of the network card.

2. Description of Prior Art

In applications of a mobile device such as a notebook, one of core indices for the mobile device is system power consumption and capability of persistence for a battery. In the system power consumption, power consumption for a network card takes a larger part. For example, the power consumption of a kilomega network card in a notebook of 12 W in an idle state is about 1 W, which is approximately 10% of the total power consumption of the notebook. Thus, manufacturers of network cards provide several power saving modes, such as a No Link (non-connection) mode and a Deep Sleep mode etc. Most of the modes are used for scenes in which there is no network wire inserted or network functions are not needed.

For power saving approaches in a network linked state, schemes provided by respective network card manufacturers are largely identical but with minor differences. For example, in a case of power supplied by the battery, a network connection is fixed in a 100 Mbps mode. This scheme does reduce the system power consumption in a certain extent for a low-load task, a small file transmission, and the idle state. However, the scheme sacrifices a bandwidth and a transmission rate of the network. For some high-load task (such as a large file transmission, a high transmission rate environment), the approach of fixed network connection mode does not enable the power consumption of the network card to be saved. Instead, the system power consumption is increased, since transmission time becomes longer.

Power saving schemes for the network card in the network connection state in prior art will be discussed below.

A current network card power saving scheme 1:

In the battery power-supplied mode, the kilomega network card is forced to be reduced into the 100 Mbps mode. In the scheme, the network connection is forced to link in the 100 Mbps mode when the battery supplies power. The network card is always in the 100 Mbps mode, regardless of the load and the transmission rate of the network. The scheme not only limits the rate in the transmission for a large file, but also increases the power supply of the system. For example, it is theoretically taken 100 s to transmit data of 10 Gb in the 100 Mbps mode, with the power consumption of about 500 mW×100 s; while it is theoretically taken 10 s in the 1 Gbps mode, with the power consumption of about 1000 mW×10 s. Obviously, even in the 100 Mbps mode, when transmission for the large load task, this scheme can not provide a better power saving effect, on the contrary, the power consumption is even higher, which is about 5 times of that in the kilomega mode. Therefore, disadvantages of the scheme are as follows:

1. The connection mode is fixed, which limits the network bandwidth and reduces the data transmission rate;

2. The power consumption may not be reduced effectively for the high-load task (such as transmission for the large file);

3. It is only used for the case in which the power is supplied by the battery, while it does not work for a case in which the power is supplied by an external source.

Thus, the power consumption and the network bandwidth may not be well balanced in the prior art, and the power savings for some special tasks are not effective.

### SUMMARY OF THE INVENTION

Accordingly, an object of the present invention is to provide a method and a device for dynamically control power consumption and a connection mode of a network card, so as to solve a problem in the prior art that the power consumption and a network bandwidth may not be well balanced, and power savings are not very effective.

For the above object, the present invention provides a method for dynamically controlling power consumption and a connection mode of a network card, comprising steps of: monitoring a data transmission state in a network in real time, and obtaining a statistic value for the data transmission state in a current or a predetermined period; obtaining a target connection mode matching with the current data transmission based on the statistic value, and switching the connection mode of the network card to the target connection mode in which the power consumption of the network card is not highest.

Preferably, the statistic value is data traffic, a data transmission rate, and/or a size of a transmission file.

Preferably, the method, before the connection mode of the network card is switched to the target connection mode, further comprises steps of: determining whether the current connection mode of the network card is a target connection mode; if so, proceeding to monitor the data transmission state in the network; otherwise, prompting a user to select to switch; if the user selects to switch, switching the current connection mode to the target connection mode; and if the user does not select to switch, keeping the current connection mode and proceeding with a current transmission task.

Preferably, the method, when the current connection mode of the network card is switched to the target connection mode, comprises in detail steps of: issuing a switching instruction to a network card driver or an application driver via a device input/output control interface; the network card driver or the application driver operating a physical layer register in a network card chip according to the switching instruction, and setting the connection mode of the network card to the target connection mode; the network card driver or the application driver performing a restart negotiation operation, negotiating with the network device according to contents in the physical layer register, and connecting in the target connection mode; and the network card operating in the target connection mode.

Preferably, the step of obtaining the target connection mode matching with the current data transmission based on the statistic value further comprises steps of: setting a first predetermined threshold, which is less than a maximum rate available in the current connection mode, wherein if current data transmission rate is larger than the first predetermined threshold, the target connection mode is a connection mode whose transmission rate is higher than that of the current connection mode; and setting a second predetermined threshold, which is less than or equal to a minimum rate suitable for the current connection mode, wherein if the current data transmission rate is less than the second predetermined threshold, the target connection mode is a connection mode whose transmission rate is lower than that of the current connection mode.

Preferably, the method further comprises a step of setting the first predetermined threshold and the second predetermined threshold by the user.

Preferably, the method further comprises a step of comparing the statistic value with the first predetermined threshold and the second predetermined threshold every predetermined time period.

Preferably, the connection mode of the network card comprises a 10 million mode, a 100 million mode, and a 1000 million mode.

For the above object, the present invention also provides a device for dynamically controlling power consumption and a connection mode of a network card, comprising: a real time monitoring unit for monitoring a data transmission state in a network in real time, and obtaining a statistic value for the data transmission state in a current or a predetermined period; an analysis and decision unit for obtaining a target connection mode matching with the current data transmission based on the statistic value, and switching the connection mode of the network card to the target connection mode in which the power consumption of the network card is not highest.

Preferably, the analysis and decision unit comprises: an instruction transmission unit for issuing a switching instruction to a network card driver via a device input/output control interface; the network card driver for operating a register in the network card, setting the connection mode of the network card to the target connection mode, performing a rebooting operation, reconnecting to the network by the network card, so that the network card operates in the target connection mode.

Preferably, the device further comprises a user operation interface unit for notifying the user of the target connection mode analysed by the analysis and decision unit, and the user selects whether to switch to the target connection mode.

Preferably, the statistic value is data traffic, a data transmission rate, and/or a size of a transmission file.

For the above object, the present invention also provides a notebook computer for dynamically control power consumption and a connection mode of a network card, comprising: a real time monitoring unit for monitoring a data transmission state in a network in real time, and obtaining a statistic value for the data transmission state in a current or a predetermined period; an analysis and decision unit for obtaining a target connection mode matching with the current data transmission based on the statistic value, and switching the connection mode of the network card to the target connection mode in which the power consumption of the network card is not highest.

Preferably, the analysis and decision unit comprises: an instruction transmission unit for issuing a switch instruction to a network card driver via a device input/output control interface; the network card driver for operating a register in the network card, setting the connection mode of the network card to the target connection mode, performing a rebooting operation, reconnecting to the network by the network card, so that the network card operates in the target connection mode.

Technical effects of embodiments according to the present invention are in that 1. In the embodiments of the present invention, when a network connection is established, it is not forced to a certain connection mode. The connection mode may be dynamically varied according to a load task by monitoring the data transmission state in the network and comparing with a switching condition. The connection mode may be dynamically switched among respective modes, so as to improve efficiency of the transmission bandwidth and implement an optimal dynamic match of the bandwidth/power consumption;

2. In the embodiments of the present invention, a variation of the load task may be adapted by varying the connection mode, so that the power consumption of the network card may be reduced, the maximum energy usage efficiency may be achieved, which is of environmental protection and energy conservation;

3. In a situation that the power consumption is gradually reduced with a technique improvement for a semiconductor device, a kilomega network is being popularized and a 10 Gbps network appears, the embodiments of the present invention will be widely used with significant advantages; and

4. The embodiments of the present invention may not increase hardware costs of the system, and may be integrated to a power management software system as a sub-system for a network management without additional costs.

### BRIEF DESCRIPTION OF THE DRAWINGS

FIG. 1 is an illustrative block diagram of a system architecture according to embodiments of the present invention;

FIG. 2 is an illustrative block diagram of a control device according to embodiments of the present invention; and

FIG. 3 is a flow chart of a method according to the embodiments of the present invention.

### DETAILED DESCRIPTION OF PREFERRED EMBODIMENTS

Hereinafter, the present invention will be further described in detail by referring to the drawings and the embodiments in order to make the objects, technical scheme and advantages of the present invention more apparent.

According to embodiments of the present invention, a connection mode in a network may be dynamically varied according to network data traffic, a transmission rate or a size of a file monitored in real time, to thereby implement an optimal dynamic match between a network bandwidth and power consumption of a network card, so as to reduce the power consumption of the network card. In a solution of the present invention, when the network is in a low load (a low rate, a small file transmission, and webpage browsing, etc.), the connection is in a low speed mode such as 10 Mbps, in which case power saving is the main object; and when the network is in a heavy load (a high rate, a large file transmission), the connection is in a high speed mode, in which case network bandwidth improvement is the main object, and at the same time, the power consumption is reduced accordingly due to increased network bandwidth and decreased transmission time.

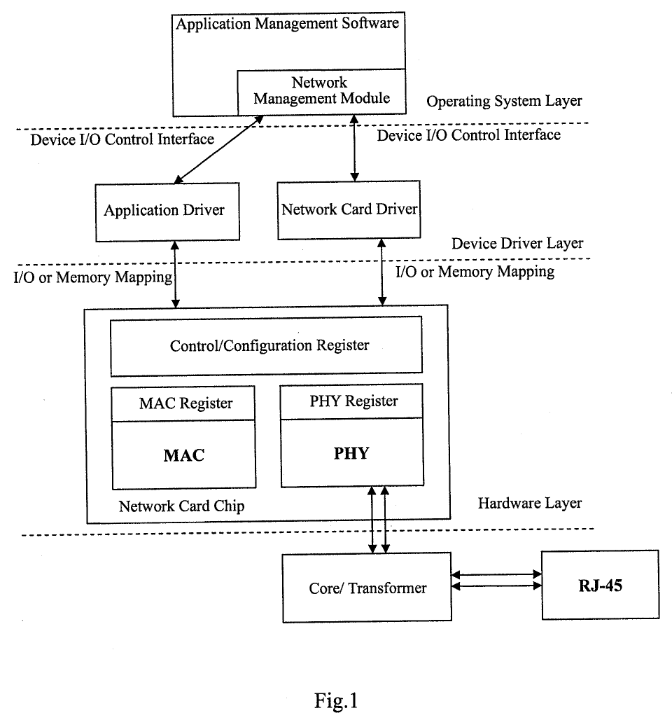

The embodiments of the present invention may be implemented by functional modules of programs. FIG. 1 is an illustrative block diagram of a system architecture according to embodiments of the present invention. A user issues to a LAN Driver (a network card driver) or an application driver an instruction for switching a connection mode via a LAN Management (a network management module, which may be integrated to a power management software) in an upper layer management interface. The LAN driver or the application driver completes setting of a corresponding register (which is mainly a connection mode register of 10/100/1000 Mbps and a corresponding matching register in a physical layer), and performs a Restart Negotiation for the network connection, so that the network card is connected in a target connection mode. Finally, the network driver reports the current connection mode to an operating system to complete switching of the connection mode.

The embodiments of the present invention requires network card manufacturers to open some interfaces for connecting their drivers to application software, so as to execute the connection mode switching instruction issued by the application software to the driver. The remaining steps may be implemented by the driver.

Functions of respective modules in the system architecture according to the embodiments of the present invention are as follows:

a first part is a network management module, which comprises a real time monitoring unit for network traffic, an analysis and decision unit, and a user operation interface;

the real time monitoring unit, for monitoring transmission state of the network in real time by a statistic program when the network is in a connection state (10/100/100 Mbps), and statistically analyzing indices such as data traffic, a transmission rate (an average value, a peak value), etc, wherein the user may set statistics time;

the analysis and decision unit, which compares the statistic data with a predetermined threshold, determines whether the current connection mode is a target connection mode matching with the current data traffic. For example, if a statistically analysed index is an average transmission rate in a recent 1 minute, the threshold is set as H: 80 Mbps, L: 8 Mbps and the current connection mode is 100 Mbps. If the statistic result shows that the average transmission rate is 60 Mbps, which is less than 80 Mbps, it is considered that the current connection mode is adapted for the current task (data traffic); otherwise, if the statistic result shows that the average transmission rate is 90 Mbps, which is higher than 80 Mbps, it is considered that the current connection mode is not adapted for the current task (data traffic). For the same reason, a corresponding threshold may also be set for the 10M connection mode. Data for the thresholds may be set based on actual applications, or an interface may be preserved for setting by the user. Of course, an optimal target connection mode for the current data traffic may be obtained according to analysis from the analysis and decision unit. Setting for the thresholds may also be an ambiguous interval such as high, median, and low etc, and a decision method in fuzzy mathematics may be applied for solving a critical problem which possibly appears;

a user operation interface, on which an analysis result of the analysis and decision unit is notified to the user, and the user selects whether to switch to the target connection mode. This part is optional, and may not be preserved if a completely automatic adjustment function is required.

A second part is an application software AP/Driver interface part. This part issues an instruction to the network card driver via a standard Device Input/Output (I/O) Controller, and notifies the driver to perform a related switching action.

A third part is a Driver/Firmware operation. When the driver receives the target connection mode, it performs a corresponding register Read/Write (R/W) operation, e.g. Auto-Negotiate bit for such as 10 Mbps, 100 Mbps etc. in the physical layer register is set to 1 (or set to 0, as required for different network cards), and performs a Restart Negotiation. Subsequent operations are consistent with original operations in the driver.

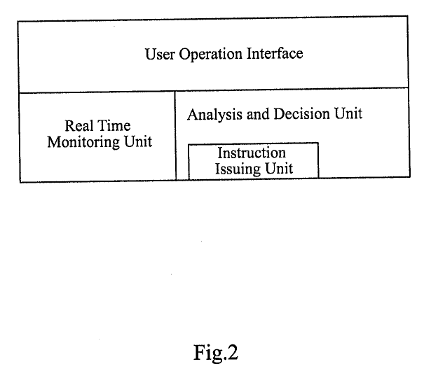

FIG. 2 is an illustrative block diagram of a control device according to embodiments of the present invention. The control device may be integrated to a network management module. As shown in FIG. 2, the control device comprises a real time monitoring unit and an analysis and decision unit. The analysis and decision unit comprises an instruction issuing unit. Alternatively, the control device may also comprise a user operation interface.

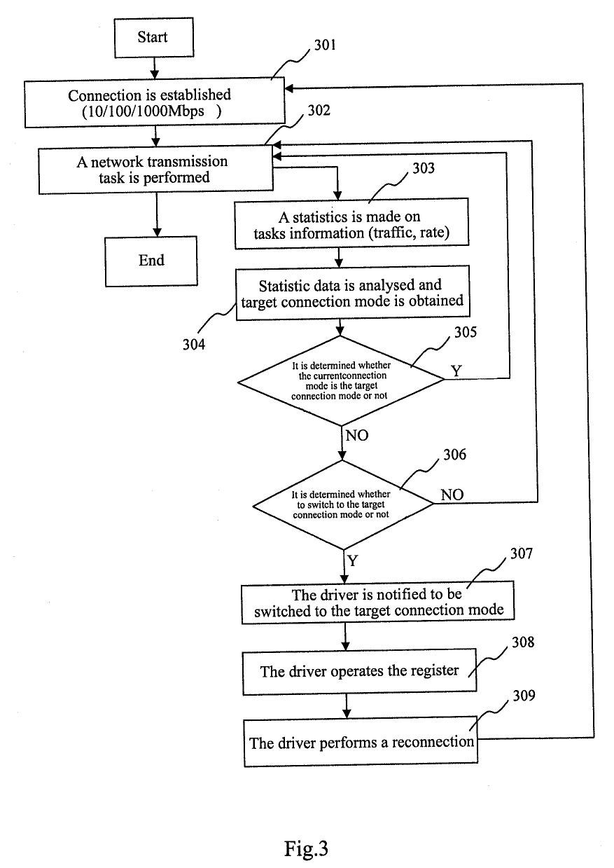

FIG. 3 is a flow chart of a method according to the embodiments of the present invention. The method according to the embodiments of the present invention comprises:

a step 301 of inserting a network cable, so as to enable a network card to negotiate with a network device and establish a connection, a connection mode thereof may be any one of 10M/100M/1000M;

a step 302 of establishing a network task connection such as a file transmission;

a step 303 of performing a network transmission task, monitoring in real time a software part to make a statistics on transmission data traffic, transmission rate, etc;

a step 304 of comparing a statistic result with a predetermined threshold every a certain period by a decision unit software part, so as to obtain a target connection mode for the current task;

a step 305 of determining whether the current connection mode is the target connection mode;

a step 306 of prompting the user of switching to the target connection mode by the user operation interface based on the determination result; if the user selects “No”, maintaining the current connection mode and proceeding with the current transmission task;

a step 307 of issuing a switching instruction to the network card driver or the application driver via a Device I/O Controller by the network management module, if the user selects “Yes”, and notifying the driver to perform related operations;

a step 308 of operating related register by the network card driver or the application driver, and forcing connection capability of the network card to a target connection rate;

a step 309 of performing a Restart Negotiation operation by the network card driver or the application driver and reconnecting to the network; and

then the network card being connected in the target connection mode to proceed with the network task.

In detailed operations, the target connection mode may be determined by steps of: setting a first predetermined threshold 80 Mbps, which is less than a saturation rate available in the current connection mode (100 Mpbs), wherein if current data transmission rate 90 Mbps, which is larger than the first predetermined threshold, the target connection mode is a connection mode whose transmission rate is higher than that of the current connection mode, i.e. 1000 Mbps mode; and setting a second predetermined threshold 10 Mbps, which is less than or equal to a minimum rate suitable for the current connection mode, wherein if the current data transmission rate is 8 Mbps, which is less than the second predetermined threshold, the target connection mode is a connection mode whose transmission rate is lower than that of the current connection mode, i.e. 10 Mbps mode.

The present invention also provides a notebook computer for dynamically control power consumption and a connection mode of a network card, comprising: a real time monitoring unit for monitoring a data transmission state in a network in real time, and obtaining a statistic value for the data transmission state in a current or a predetermined period; an analysis and decision unit for obtaining a target connection mode matching with the current data transmission based on the statistic value, and switching the connection mode of the network card to the target connection mode in which the power consumption of the network card is not highest.

The method of the embodiments according to the present invention may be used as a function in a sub-system “Network Management Module” in a power management system, which function may be enabled/disabled by the user. In a mode of supplying power by an external source, the user will not worry about the problem of power consumption, the function may be disabled. In a mode of supplying power by a battery, the power consumption is a key problem, the function may be enabled. Therefore, according to the present invention, power may be saved in maximum, and a user experience may not be affected. Furthermore, the switching is performed in a physical layer, and packets may be possibly lost during the switching process, but TCP layer and application layer connections may be not affected. Thus, the network transmission tasks may not be interrupted, since packets may be lost even if it is in a normal network transmission state, and this problem may be solved by retransmission. It shows in experiments by a Ping . . . t command that only one packet is lost during the switching process. Thus, the network transmission task may not be affected.

The embodiments of the present invention may not only be used for a battery power supply mode to enhance capability of persistence for the battery, but also be used for an AC adaptor power supply mode to save power consumption of a system and improve the capability of environmental protection. With the rapid development in the semiconductor technique, the power consumption of the system may be greatly reduced with an improved manufacture process. And as a kilomega network is being popularized and a 10 Gbps network appears, the embodiments of the present invention will be widely used with significant advantages.

As seen from above, advantages of the embodiments of the present invention are in that:

1. In the embodiments of the present invention, when a network connection is established, it is not forced to a certain connection mode. The connection mode may be dynamically varied according to a load task by monitoring the data transmission state in the network and comparing with a switching condition. The connection mode may be dynamically switched among respective modes, so as to improve efficiency of the transmission bandwidth and implement an optimal dynamic match of the bandwidth/power consumption;

2. In the embodiments of the present invention, a variation of the load task may be adapted by varying the connection mode, so that the power consumption of the network card may be reduced, the maximum energy usage efficiency may be achieved, which is of environmental protection and energy conservation;

3. In a situation that the power consumption is gradually reduced with a technique improvement for a semiconductor device, a kilomega network is being popularized and a 10 Gbps network appears, the embodiments of the present invention will be widely used with significant advantages; and

4. The embodiments of the present invention may not increase hardware costs of the system, and may be integrated to a power management software system as a sub-system for a network management without additional costs.

The above is only the preferred embodiments of the present invention and the present invention is not limited to the above embodiments. Therefore, any modifications, substitutions and improvements to the present invention are possible without departing from the spirit and scope of the present invention.

1. A method for dynamically controlling power consumption and a connection mode of a network card, the method comprising steps of:
monitoring a data transmission state in a network in real time, and obtaining a statistic value for the data transmission state in a current or a predetermined period; and
obtaining a target connection mode matching with current data transmission based on the statistic value, and switching the current connection mode of the network card to the target connection mode, wherein the power consumption of the network card is not highest while the current connection mode is the target connection mode.

2. The method according to claim 1, wherein the statistic value is data traffic, a data transmission rate, or a size of a transmission file.

3. The method according to claim 1, wherein before switching the current connection mode of the network card to the target connection mode, the method further comprises steps of:
determining whether the current connection mode is the target connection mode; switching the current connection mode to the target connection mode if the current connection mode is not the target connection mode.

4. The method according to claim 1, wherein switching the current connection mode of the network card to the target connection mode comprising:
receiving a switching instruction via a device input/output control interface;
operating a physical layer register of the chip of the network card according to the switching instruction, and setting the target connection mode as the current connection mode.

5. The method according to claim 1, wherein obtaining a target connection mode matching with current data transmission based on the statistic value comprises:
setting a first predetermined threshold being less than maximum data transmission rate allowed under the current connection mode, wherein if the data transmission rate of the current data transmission is higher than the first predetermined threshold, the data transmission rate of the target connection mode is higher than the data transmission of the current connection mode; and
setting a second predetermined threshold being less than or equal to a minimum data transmission rate allowed under the current connection mode, wherein if the data transmission rate of the current data transmission is less than the second predetermined threshold, the data transmission rate of the target connection mode is lower than the data transmission of the current connection mode.

6. The method according to claim 5, wherein the method further comprises a step of comparing the statistic value with the first predetermined threshold or the second predetermined threshold every a predetermined time period.

7. The method according to claim 5, wherein the current connection mode is a 10 million mode, a 100 million mode, or a 1000 million mode.

8. A device for dynamically controlling power consumption and a connection mode of a network card, the device comprising:
a real time monitoring unit for monitoring a data transmission state in a network in real time, and obtaining a statistic value for the data transmission state in a current or a predetermined period; and
an analysis and decision unit for obtaining a target connection mode matching with the current data transmission based on the statistic value, and switching the current connection mode of the network card to the target connection mode wherein the power consumption of the network card is not highest while the current connection mode is the target connection mode.

9. The device according to claim 8, wherein the analysis and decision unit comprises:
an instruction transmission unit for issuing a switching instruction to a network card driver via a device input/output control interface; and
the network card driver for operating a register in the network card, setting the target connection mode as the current connection mode.

10. The device according to claim 8, further comprises a user operation interface unit for notifying the user of the target connection mode analyzed by the analysis and decision unit, and wherein the user selects whether to switch to the target connection mode.

11. The device according to claim 8, wherein the statistic value is data traffic, a data transmission rate, or a size of a transmission file.

12. A notebook computer for dynamically controlling power consumption and a connection mode of a network card, the notebook computer comprising:
a real time monitoring unit for monitoring a data transmission state in a network in real time, and obtaining a statistic value for the data transmission state in a current or a predetermined period; and an analysis and decision unit for obtaining a target connection mode matching with the current data transmission based on the statistic value, and switching the connection mode of the network card to the target connection mode, wherein the power consumption of the network card is not highest while the current connection mode is the target connection mode.

13. The notebook computer according to claim 12, wherein the analysis and decision unit comprises:
an instruction transmission unit for issuing a switching instruction to a network card driver via a device input/output control interface; and
the network card driver for operating a register in the network card, and setting the target connection mode as the current connection mode.
